(19) United States
(12) Patent Application Publication
(10) Pub. No.: US 2026/0244601 A1
(43) Pub. Date: Aug. 20, 2026

(54) Delayed Data Synchronization

(71) Applicant: Oracle International Corporation, Redwood Shores, CA (US)

(72) Inventors: Allen Roshan D’Souza, Houston, TX (US); Dipen Ashvinkumar Joshi, Katy, TX (US); Ankur Handa, Santa Clara, CA (US); Mukesh Tyagi, Aldie, VA (US); Shovan Sutar, Palo Alto, CA (US); Srikanth Reddy Surapu, Bridgewater, NJ (US); Konatham Chandrajith Yadav, Hyderabad (IN); Shashi Kanth Gottipati, Hyderabad (IN); Venkata Narsimha Rao Gurrapu Srinivas, Hyderabad (IN)

(73) Assignee: Oracle International Corporation, Redwood Shores, CA (US)

(21) Appl. No.: 19/306,267

(22) Filed: Aug. 21, 2025

Related U.S. Application Data
(60) Provisional application No. 63/760,381, filed on Feb. 19, 2025.

(51) Int. Cl. G06F 16/178; G06F 16/182

(52) U.S. Cl. CPC G06F 16/178; G06F 16/184

(57) ABSTRACT

Techniques for managing synchronization of datasets stored in multiple memory locations are disclosed. A system maintains a reference dataset and a computational dataset corresponding to the reference dataset in different memory locations. In response to detecting an update to a reference dataset, a system detects an execution status of a computational process that uses the computational dataset. Based on the execution status of the computational process, the system determines whether to update the reference dataset or refrain from updating the reference dataset.

### BENEFIT CLAIMS; RELATED APPLICATIONS; INCORPORATION BY REFERENCE

This application claims the benefit of U.S. Provisional Patent Application 63,760,381, filed Feb. 19, 2025, that is hereby incorporated by reference.

### TECHNICAL FIELD

The present disclosure relates to synchronizing data between data storage locations.

### BACKGROUND

Computer systems synchronize data between multiple storage locations to maintain consistency. When data is changed in one storage location, synchronization propagates the changes across the other storage locations to allow different computing systems to access the same data. For example, a computer may store a backup copy of a primary storage device in a secondary storage device. In response to changes to the data in the primary device, the computer may update the secondary device to ensure the backup reflects the changes.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a functional block diagram of an example data synchronization architecture in accordance with one or more embodiments;

FIG. 1B illustrates a system block diagram of an example data synchronization architecture in accordance with one or more embodiments;

FIG. 2 illustrates an example set of operations for synchronizing datasets in accordance with one or more embodiments;

FIGS. 3A, 3B, and 3C illustrate example data structures used for synchronizing datasets in accordance with one or more embodiments;

FIG. 4 illustrates a system block diagram showing an example embodiment of data synchronization system that synchronizes datasets in accordance with one or more embodiments;

FIG. 5 illustrates a machine learning (ML) engine in accordance with one or more embodiments;

FIG. 6 illustrates the operation of an ML engine in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES & IMPROVEMENTS
3. SYNCRONIZATION MANAGEMENT ARCHITECTURE
4. DELAYING SYNCRONIZATION
5. EXAMPLE OF DELAYING SYNCRONIZATION
6. MACHINE LEARNING ARCHITECTURE
7. HARDWARE OVERVIEW
8. MISCELLANEOUS; EXTENSIONS

### 1. General Overview

One or more embodiments intentionally delay an update process for updating and synchronizing a computational dataset with a corresponding reference data. A system may delay the update process based on an execution status of computational processes that accesses the computational dataset and/or based on a synchronization state corresponding to the computational dataset.

A reference dataset, as referred to herein, maintains current data and is updated based on changes to information within the reference dataset. The system may, for example, immediately update the reference dataset in response to detecting a change in the information within the reference dataset.

A computational dataset includes a copy of at least a portion of the reference dataset. One or more computational processes access the computational dataset as a source of information. When the reference dataset is updated with new information, the computational dataset temporarily becomes out-of-date as it is no longer synchronized with the reference dataset that maintains the current data.

A synchronization pipeline, also referred to herein as an update process for the computational dataset, is configured to update the computational dataset based on updates that are made to the reference dataset. Prior to updating the computational dataset based on the reference data, i.e., prior to synchronizing the computational dataset with the reference dataset, the system evaluates whether the updating and synchronizing operations are to be intentionally delayed.

The system monitors the status of one or more computational processes that are to be executed based on a current version of the computational dataset. Based on the status, the system determines whether the computational processes are still pending (e.g., uninitiated), current executing, or completed. In response to detecting a computational process that is (a) to be executed on the current version of the computational dataset and (b) not been completed, the system refrains from initiating the update process for the computational dataset that synchronizes the computational dataset with the reference dataset. This intentionally delaying of the updating and synchronizing operations results in maintaining outdated data in the computational dataset. In response to detecting that there are no incomplete computational processes that are to be executed on the current version of the computational dataset, the system proceeds with updating the computational dataset to synchronize the computational dataset with the reference dataset.

In the same or different embodiment, the system determines the synchronization state associated with the computational dataset. An active synchronization state indicates that updates to the computational dataset to synchronize the computational dataset with the reference dataset are currently permitted. An inactive or disabled synchronization state indicates that updates to the computational dataset to synchronize the computational dataset with the reference dataset are not currently permitted. The system may compute and store the synchronization state associated with the computational dataset based in part whether any computational process that is to be executed on a current version of the computational dataset has been or not been completed. If at least one computational process, that is to be executed based on the current version of the computational dataset, is incomplete, then the synchronization state is set to inactive or disabled. If there are no incomplete computational processes that are to be executed based on the current version of the computational data, the then synchronization state is set to active. In response to determining that the synchronization state for the computational dataset is set to active, the system executes the update process that updates the computational dataset based on changes made to the reference dataset. In response to determining that the synchronization state for the computational dataset is set to inactive or disabled, the system refrains from initiating the update process that updates the computational dataset based on changes made to the reference dataset.

One or more embodiments described in this Specification and/or recited in the claims may not be included in this General Overview section.

### 2. Practical Applications, Advantages & Improvements

Embodiments in accordance with the present disclosure enhance version management of computing data stored in multiple locations by conditionally synchronizing datasets. Example systems optimize synchronization of the versions by conditionally delaying synchronization of particular datasets. By doing so, computing systems avoid processing errors caused by prematurely enforcing consistency among versions of a dataset. For example, embodiments prevent processing errors, such as generating faulty commands or outputs based on incorrect data resulting from premature synchronization. Conditionally delaying synchronization also prevents computing systems from performing unnecessary processing to conserve bandwidth and reduce latency for other computing operations, such as high-priority processes. The stability and reliability of the system is thereby improved by reducing the likelihood of processing errors while maintaining operational efficiency.

### 3. Syncronization Management Architecture

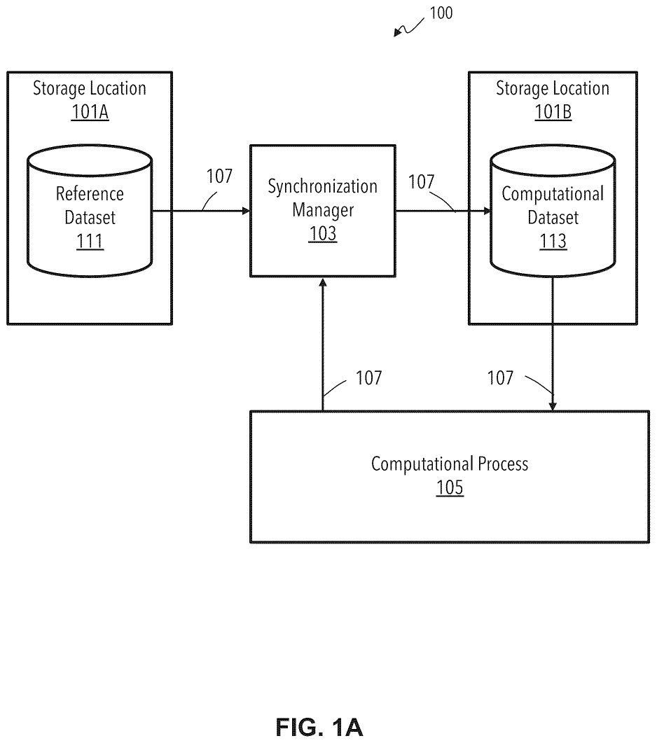

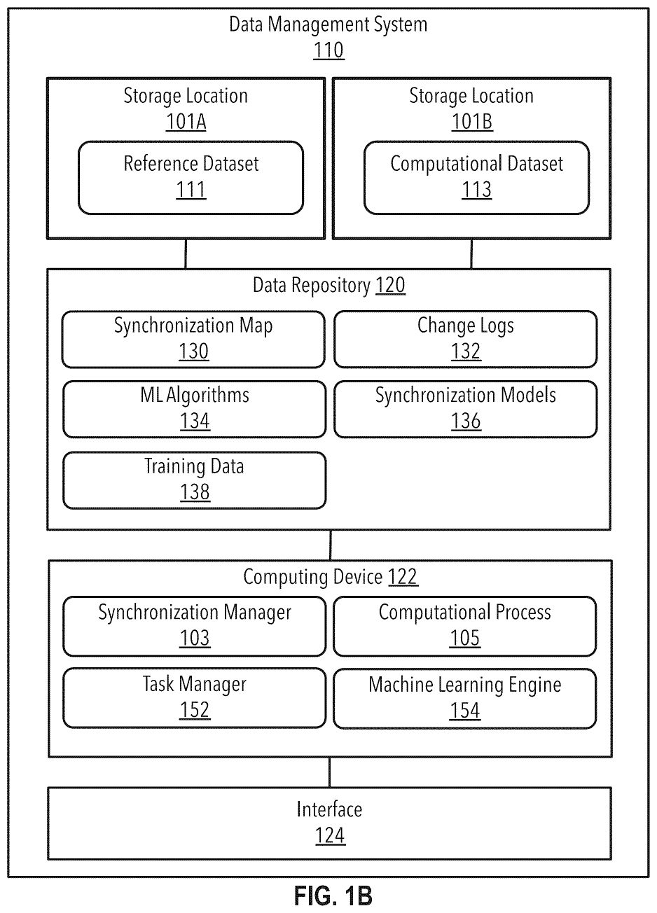

FIG. 1A illustrates an example data synchronization management architecture 100 in accordance with one or more embodiments. Embodiments of the architecture 100 manage versions of datasets stored in multiple locations by conditionally delaying synchronizing of the datasets. As illustrated in FIG. 1A, the architecture 100 includes storage locations 101A and 101B, a synchronization manager 103, and a computational process 105 that are communicatively connected, directly or indirectly, via one or more communication links 107. In one or more embodiments, the architecture 100 may include more or fewer components than the components illustrated in FIG. 1A. The components illustrated in FIG. 1A may be local to or remote from one another. The components illustrated in FIG. 1A may be implemented in software and/or hardware. The individual component may be distributed over multiple applications and/or machines. Multiple components may be combined into one application and/or machine. Operations described with respect to one component may instead be performed by another component.

The storage locations 101A and 101B are computer-readable memories any type of storage unit or device (e.g., a file system, database, collection of tables, or any other storage mechanism). For example, the storage locations 101A and 101B can include one or more of a magnetic storage device (e.g., hard disk drives), a solid state drive (SSD), an optical storage device (e.g., compact disk or digital video disk), random access memory (RAM), a read-only memory (ROM), flash memory, an electrically erasable/programmable read-only memory (EEPROM), cache memory, or other computer-readable storage devices. Furthermore, the storage locations 101A and 101B may include multiple different storage units and/or devices. The storage locations 101A and 101B may or may not be of the same type or located at the same physical site. Furthermore, the storage location 101A may be implemented in the same storage unit or device, or in the same computing system as storage location 101B, synchronization manager 103, and the computational process 105.

The communication links 107 include wired and/or wireless information communication channels, such as the Internet, an intranet, an Ethernet network, a wireline network, a wireless network, a mobile communications network, and/or another communication network. For example, the storage locations 101A and 101B may communicate with the synchronization manager 103 and the computational process 105 via the Internet by exchanging data packets through a Wi-Fi or cellular data network connection.

The synchronization manager 103 is computer hardware, software, or a combination thereof that manages the synchronization between the storage locations 101A and 101B. One or more embodiments of the synchronization manager 103 conditionally delay synchronization of a reference dataset 111 stored by the storage location 101A with a computational dataset 113 stored by the storage location 101B. As detailed below, the synchronization manager 103 applies rules and models to determine whether or not to delay synchronization of the computational dataset 113 with the reference dataset 111 based on the execution status of the computational process 105 and/or the synchronization state of the computational dataset 113.

The computational process 105 is hardware, software, or a combination of hardware and software that executes software using computational dataset 113. Example software include applications, modules, daemons, services, or utilities that execute functions or tasks executed by a computing system. Some examples used herein describe the computational process 105 as processing income tax forms. It is understood that embodiments are not limited to this example and that the computational process 105 may be facilities control system or any computer system or process that executes computer-readable program instructions using the computational dataset 113.

FIG. 1B is a block diagram illustrating an example data management system 110 in accordance with one or more embodiments. The data management system 110 includes hardware and software that perform processes and functions described herein. In one or more embodiments, the data management system 110 includes more or fewer components than the components illustrated in FIG. 1B. The components illustrated in FIG. 1B can be local to or remote from one another. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the data management system 110 include the storage location 101A and the storage location 101B that store the reference dataset 111 and computational dataset 113, respectively. Additionally, the data management system 110 includes a data repository 120 and a computing device 122. The data repository 120 includes any type of storage unit and/or device (e.g., a file system, database, collection of tables, or any other storage mechanism) for storing data. Furthermore, the data repository 120 may include multiple different storage units and/or devices. The multiple different storage units and/or devices may or may not be of the same type or located at the same physical site. Furthermore, the data repository 120 can be implemented or executed on the same computing system as the data management system 110. Additionally, or alternatively, the data repository 120 may be implemented or executed on a computing system separate from the data management system 110. The data repository 120 can be communicatively coupled, wired and/or wirelessly, to the data management system 110 via a direct connection or via a network.

In one or more embodiments, the data repository 120 stores a synchronization map 130, change logs 132, ML algorithms 134, synchronization models 136, and training data 138. The synchronization map 130 is one or more data structures corresponding to datasets, such as datasets 111 and 113, that associate synchronization rules, states, and data with the datasets for determining whether or not to delay synchronization of the computational dataset 113. The synchronization rules are policies, requirements, and/or limitations that specify one or more conditions, events, or thresholds used to determine the synchronization states of corresponding datasets. The synchronization states indicate if synchronization of a dataset should be active or disabled (e.g., inactive or paused). For example, the synchronization rules may specify that datasets including values that are rarely or never updated (e.g., social security numbers or birthdates) are paused to prevent unnecessary data transmissions and processing. Other synchronization rules may pause synchronization until after a particular date/time, event, or condition is met. For example, a synchronization rule may delay synchronization until after a specific user action is completed or input is received, a threshold date is reached, or a dependent process is successfully executed. The synchronization data is information that is applied as an input to synchronization rules to evaluate and determine if the conditions for pausing synchronization have been met. Example synchronization data includes dates, times, statuses, and events corresponding to respective computational processes. For instance, synchronization data may include timestamps that indicate the most recent execution of a computational process, a planned execution date of the computational process, and indication of whether execution of the process is pending, complete, or idle.

The change logs 132 are one or more data structures that record associations between datasets and modification timestamps indicating when a dataset was last changed. For example, individual datasets used for a tax form processing may be associated with an entry in the change logs 132. The log records the dataset's unique identifier along with the timestamp of the most recent modification. By comparing timestamps for different versions of the dataset, the system 110 can determine if the dataset should be synchronized.

In one or more embodiments, the ML algorithm 134 is an algorithm that can be iterated to train a target model f that best maps a set of input variables to an output variable. In particular, the ML algorithm 134 is configured to generate and/or train the synchronization models 136. The ML algorithm is an algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the ML algorithm that, in turn, updates the target model f.

A ML algorithm 134 generates a target model f such that the target model f best fits the datasets of training data to the labels of the training data. Additionally, or alternatively, a ML algorithm 134 generates a target model f such that when the target model f is applied to the datasets of the training data, a maximum number of results determined by the target model f matches the labels of the training data. Different target models may be generated based on different ML algorithms and/or different sets of training data.

The ML algorithm 134 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The synchronization models 136 are ML models trained to make predictions, recognize patterns, or perform tasks without being explicitly programmed for individual decisions. One or more of the synchronization models 136 are trained to determine whether or not to delay synchronization of datasets based on a set of parameters. For example, a dataset comprising an employee record may include data items used for processing a tax form, such as name, birthdate, social security number, home address, state/province, country, filing status, dependents, deductions, dates of address changes, dates of filing status changes, and dates of added dependents along with similar data from the current and past tax filings. Additional parameters associated with the dataset may include, for example, conditional processes and data, trigger events and thresholds, conditions, and categories, or policies, of the employer. Based on the combination of the data and the parameters, a synchronization model 136 may be trained to determine an output indicating whether or not to pause synchronizing of a dataset.

The set of training data 138 for a synchronization model 136 includes feature vectors representing characteristics of the computational dataset and/or characteristics of the computations, and timing information indicating when to update/synchronize the computational dataset 113 with the reference dataset 111. When the synchronization model 136 is applied to characteristics of a target computational dataset 113 and/or characteristics of a target process, the synchronization model 136 outputs timing information indicating timing for executing a synchronization process to synchronize the target computational dataset 113 with the reference dataset 111. The timing information is used to determine whether the synchronization state for the computational dataset 113 is in a disabled state or an active state.

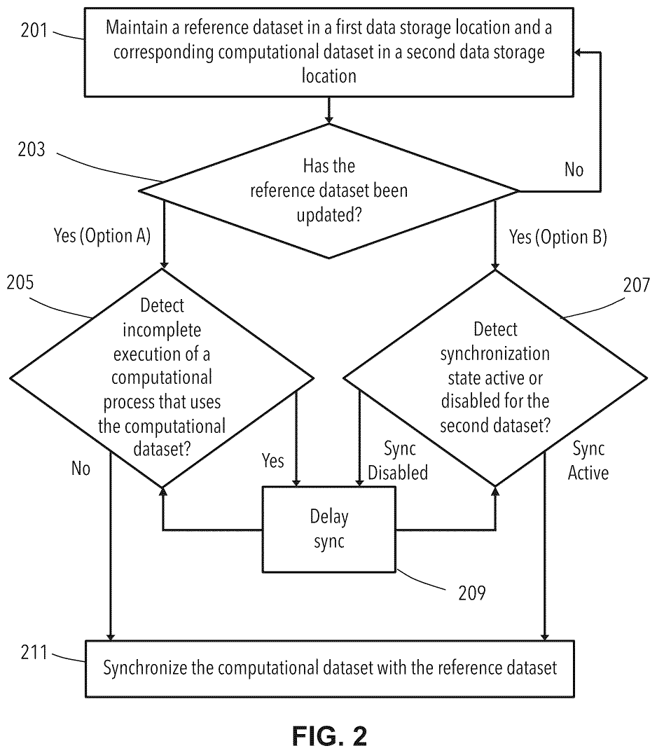

In one or more embodiments, the computing device 122 includes hardware and/or software configured to perform operations described herein. Example operations are described below with reference to FIG. 2. The computing device 122 executes computer-readable program instructions, such as an operating system and application programs, that are stored in memory devices and/or the storage system. Additionally, the computing device 122 executes program instructions of the synchronization manager 103, the computational process 105, a task manager 152, and a ML engine 154. The synchronization manager 103 and the computational process 105 may be the same as described above.

The task manager 152 manages the execution of tasks by the data management system 110. The task manager 152 schedules, prioritizes, monitors, and allocates resources for the execution of tasks and processes, such as computational process 105. Managing a task or process includes identifying and managing the execution status of the task or process as well as classifying the execution status as pending, in progress, or complete. For example, the task manager 152 may monitor various parameters, such as status flags, process identifiers, and execution logs, to determine the current status of tasks. For example, the task manager 152 may define the execution parameters, including its dependencies and triggers for execution allowing the task manager 152 to identify whether the computational process 105 is actively executing, waiting on a prerequisite, failed, or has been completed. Upon completion, the task manager 152 may confirm successful execution and update the synchronization map 130 or other log indicate status of the computational process 105 as being complete.

The ML engine 154 may execute one or more of the ML algorithms 134 to train one or more synchronization models 136. For example, the ML engine 154 may retrieve attributes extracted from a set of training data and convert the attributes to feature vectors to generate computer-readable features optimized for the ML algorithms 134 and/or synchronization models 136. Using the feature vectors, the ML engine 154 may use a ML algorithms 134 to train a synchronization model 136 to determine whether or not to delay synchronization of the computational dataset 113.

The interface 124 refers to hardware and/or software that facilitates communications between a user and agents. The interface 124 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, different components of interface 124 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 124 is specified in one or more other languages, such as Java, C, or C++.

### 4. Delaying Syncronization

FIG. 2 illustrates an example process comprising a set of operations for conditionally delaying synchronization of corresponding datasets in accordance with one or more embodiments. One or more operations illustrated in FIG. 2 may be modified, rearranged, or omitted. Accordingly, the particular sequence of operations illustrated FIG. 2 should not be construed as limiting the scope of one or more embodiments.

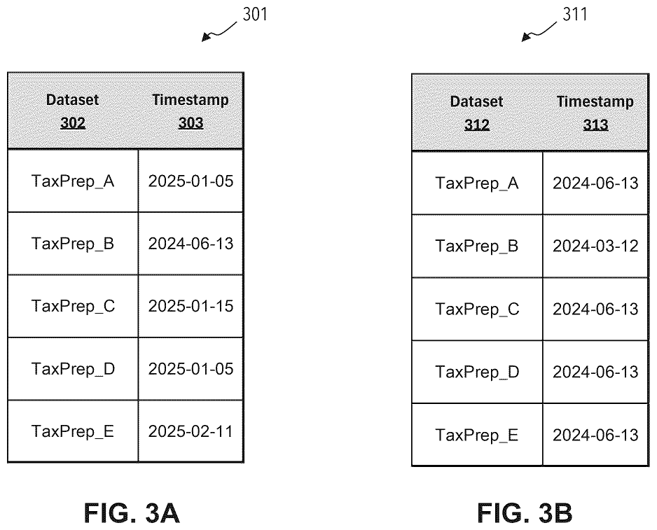

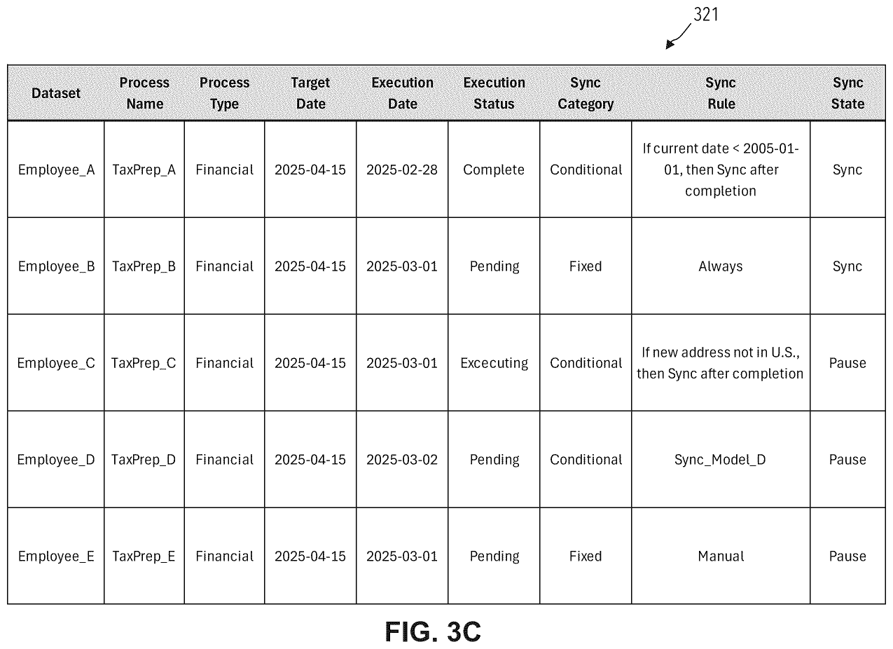

In an embodiment, a system maintains a reference dataset in a first data storage location and a corresponding computational dataset in a second data storage location (Operation 201). The first data storage location and the second data storage location may be included in the memory of the same storage device or in the memories of different storage devices. The computational dataset may be a version, a copy, a backup, or a cache of data included in the reference dataset. Some embodiments of the computational dataset are a derivative or subset of the reference dataset. Maintaining the datasets includes updating the values of data items in the datasets and recording timestamps that indicate the date and/or time of the changes. Updating the values may include receiving and replacing data for one or more data items in the datasets. For example, in the context of an income tax processing platform, the reference dataset may be a database record that stores tax information of an individual, such as name, birthdate, social security number (SSN), address, filing status, and number of dependents. The employee may submit updated information for the record, changing the employee's name, address, filing status, and number of dependents. The system may store the updated data and log a timestamp that indicates the date and/or time of the modification to the dataset. For example, FIG. 3A illustrates a data structure 301 associating reference datasets 302 with respective modification timestamps 303. FIG. 3B illustrates an example data structure 311 storing computational datasets 312 with respective modification timestamps 313 corresponding the datasets 302 and modification timestamps 303. Differences between the datasets 302 and timestamps 303 and the corresponding datasets 312 and timestamps 313 indicate if one or more of the computational datasets 312 are out of date in relation to the respective reference datasets 302.

The system detects if the reference dataset has been updated (Operation 203). The system may determine if the reference dataset has been updated to generate an updated reference dataset using periodic checks or in response to specific conditions, events, or triggers. The system may schedule periodic checks for updates to the reference dataset at fixed intervals, such as hourly or daily, to detect the reference dataset's status. The system may determine that an update has occurred by checking an update flag, timestamp, or checksum of the reference dataset. For example, the system may compare a checksum of the reference data set to a previous checksum. Additionally, the system may determine an updated reference dataset has been generated based on the occurrence of event, such as queuing or executing a process that uses the computational dataset. Furthermore, the system may check for generation of an updated reference dataset in response to an event, such as receiving a request for data synchronization, detecting user access to an associated dataset, or identifying changes in system resources, such as available bandwidth or storage capacity. Referring to FIGS. 3A and 3B, the system may periodically compare the timestamps 303 and 313. If the system determines that the reference dataset has not been updated, then the process iteratively returns to maintaining the datasets.

If the system determines that the reference dataset has been updated, then the process may follow one or more operational flows that determine whether or not to delay synchronization of the computational dataset. In a first operational flow, the system detects if execution of a computational process that uses the computational dataset is incomplete (Operation 205). Some embodiments determine if the computational process is incomplete or complete using a task scheduling module or a task management module that monitors and updates the execution status of processes based on various parameters, such as resource availability, user inputs, or the completion of dependent processes. The computational process may be incomplete if the process is, for example, pending, executing, or failed. For example, the computational process may be incomplete when execution of the process is pending but has not yet started due to various conditions, such as resource constraints, dependencies, prioritization rules, and scheduling. Additionally, the computational process may be incomplete if the process is actively analyzing data in the computational dataset. Furthermore, the computational process may be incomplete if the process failed to complete due to an error or interruption during execution.

If the system determines that execution of the computational process is incomplete, then the system delays the synchronization of the computational dataset (Operation 209). Delaying synchronization includes refraining from initiating an update process for updating the computational dataset based on the updated reference dataset. For example, the system may refrain from replacing or modifying data in the computational dataset and timestamps corresponding to the computational dataset to avoid introducing inconsistencies to the computational process and outputs of the process.

If the system determines that execution of the computational process is complete, then the system synchronizes the computational dataset using the updated reference dataset (Operation 211). Synchronization includes initiating the update process for updating the computational dataset based on the updated reference dataset. For example, the system may identify new entries in the reference dataset that reflect recent changes to reference data sources and merge these entries into the computational dataset to ensure that the dataset reflects the most current information available. Synchronizing the datasets may include replacing the computational dataset with a copy of the entire reference dataset. Alternatively, synchronizing the datasets may include replacing only the updated information of the reference dataset in the computational dataset based on respective timestamps. For example, the system may replace the values of out-of-date data items in the computational dataset with the superseding values from the reference dataset.

Additionally, or alternatively, in response to detecting that the reference dataset has been updated (Operation 203), a second operational flow that detects if a synchronization state of the computational dataset is active or disabled (Operation 207). The synchronization state indicates one of: (a) that the computational dataset is not to be synchronized with the updated reference dataset when a computational process has not been completed, and (b) the computational dataset is to be synchronized with the updated reference dataset when the computational process that uses the second dataset has been completed. The detection of the synchronization state may be based on the current execution status of the computational process and/or based on a corresponding rule or synchronization model for the process. For example, FIG. 3C illustrates an example data structure 321 storing a synchronization map associating datasets (e.g., “Employee_A”) with a corresponding computational processes (e.g., “TaxPrep_A”), process type, target execution date, actual execution date, an execution status (e.g., idle, pending, executing, or complete), a synchronization category (e.g., fixed or conditional), a synchronization rule, and a synchronization state (e.g., “Sync” or “Pause”).

The synchronization category classifies individual datasets or portions thereof as fixed synchronization and conditional synchronizations. The categories can be set based on past use or by user input. Fixed synchronization may be associated with a synchronization rule that the dataset should be always synchronized, never synchronized, or manually synchronized. The system updates a dataset that is always synchronized regardless of conditions or events. The system does not update a dataset that is never synchronized regardless of conditions or events. For example, a dataset, or a portion thereof, that essentially never changes may be categorized as never synchronize. A dataset that is manually synchronized is updated based on an explicit user input. In some cases, a manually synchronized dataset is set to a default to a state, such as not synchronized, unless a user input is received that changes the state.

A dataset that is conditionally synchronized may be associated with a rule or an ML model used by the system to evaluate whether or not to delay synchronization of the dataset. The evaluation may be based on one or more of time, location, thresholds, processing parameters, or storage parameters. For example, a synchronization rule for a particular dataset, or a portion thereof, may specify that synchronization should be delayed until a certain date (e.g., “2025-01-01”). Additionally, a rule may specify that synchronization of the dataset should be delayed until an associated event or precondition has occurred, such as a particular process completing or a related dataset updating. Moreover, an example rule may specify that synchronization should be delayed unless a location (e.g., an address) is within a particular geographic region. Furthermore, a rule may specify that synchronization should not occur unless a predetermined amount of time has passed since a previous update or a predetermined quantity of data items in the dataset have been updated.

Additionally, decision logic or an ML model may be applied to determine whether or not to synchronize the datasets or portions thereof. For example, as illustrated in FIG. 3C, a rule corresponding to the dataset “Employee_D” may cause the system to execute corresponding decision logic or ML model “Sync_Model_D” that determines whether or not to delay synchronization based on a combination of parameters, such as process type, target date, execution date execution status, etc. Additionally, the logic and model may consider additional parameters apart from those corresponding to datasets. For example, an ML model may consider parameters of an employer, employee, the processing system, and other processes, such as type, size, capacity, status, and policies.

If the system detects that the synchronization state is disabled, then the system delays the synchronization as previously described above (Operation 209). The system then iteratively returns to detecting the synchronization state of the computational dataset (Operation 207). On the other hand, if the system detects that the synchronization state is active, then the system synchronizes the computational dataset with the reference dataset as previously described above (Operation 211).

### 5. Example of Delaying Synchronization

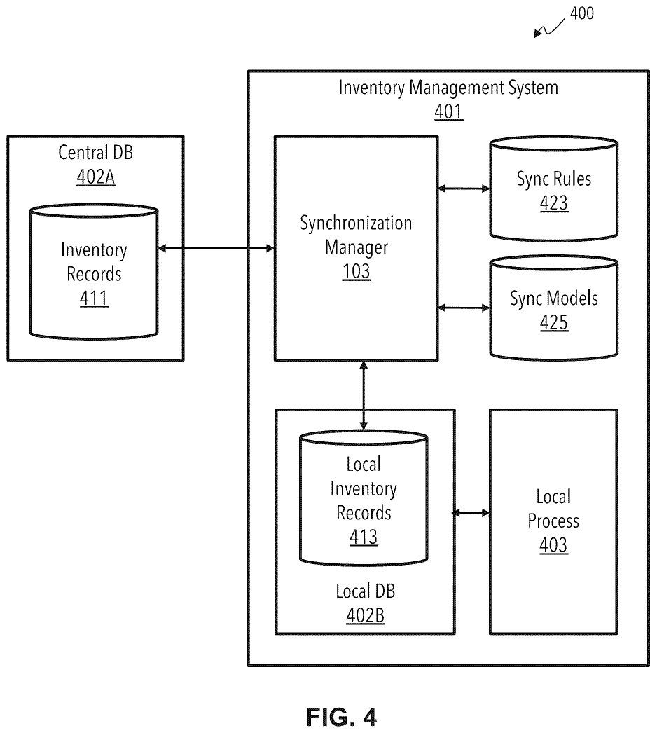

FIG. 4 illustrates a system block diagram showing an example of synchronizing records in an inventory management environment 400 in accordance with one or more embodiments. The environment 400 synchronizes data of inventory levels across multiple storage locations. A central database 402A stores a current version of inventory records 411 for various locations in the environment 400. For example, the central database 402A may maintain and update records of a central warehouse identifying inventory received for and/or allotted to different locations. An inventory management system 401 at one of the locations includes a local database 402B that stores local inventory records 413 that include a version of at least a portion of the inventory records 411 associated with the location. Additionally, the inventory management system 401 executes a local process 403 that uses the local inventory records 413 to perform computations such as calculating local prices.

The inventory management system 401 conditionally updates the local inventory records 413 to synchronize the local inventory records 413 with the inventory records 411 at the central database 402A. In the present example, changing the quantity of stock in the local inventory records 413 affects the local process 403 that uses the local inventory records 413 to calculate seasonal discounts and pricing. If the local inventory records 413 for a current season are prematurely updated using the inventory records 411 to include inventory for the next season, then the local process 403 may incorrectly change the pricing at the location for the current season. The changes may also affect other processes that depend on the pricing to make predictions of, for example, revenue and profit. For example, a related processes may use the output of the local process 403. As such, the system 401 determines whether or not to refrain from initiating an update of the quantity of stock in the local inventory records 413. The system 401 may delay updating until one or more of: the local process 403 completes a workload using local inventory records 413; the local process 403 generates a set of outputs based on the local inventory records 413; a certain date has passed; or a predefined event has occurred. For example, the system 401 may determine to delay updating the local inventory records 413 until a pending sale of existing stock is complete or until a seasonal deadline has passed.

The system 401 determines whether or not to refrain from initiating an update process of the local inventory records 413 based on the execution status of the local process 403 using one or more synchronization rules 423 or synchronization models 425 that output values indicating if the synchronization of the local inventory records 413 is paused or active. For example, the synchronization rules 423 may include deterministic logic that sets a synchronization state of the process 403 to “pause” until a particular date at the end of the current season. Additionally, or alternatively, the synchronization model 425 may be trained to predict the optimal timing for synchronization based on multiple parameters associated with the local process 403, such as pending data and approvals, dependent processes, reporting policies, contractual requirements, and regulations. The synchronization model 425 may receive input features that represent some or all of the parameters. Based on the features, the synchronization model 425 outputs a synchronization state indicating if synchronization should be paused. By using a machine-learning synchronization model, the system 401 may adapt decisions over time based on changing conditions and system feedback.

While the example above describes synchronization of inventory records between a central database and a local database, the techniques disclosed herein may be applied to other technologies. In one example, a cloud computing system includes a central node that maintains configuration data for remote nodes. An individual remote node executes a process based on a current configuration. The remote node may delay propagation of updated configuration data based on an execution state of a local process. By deferring configuration updates until completion of the local process, the system avoids creating inconsistencies or causing service interruptions.

In another example, a distributed software system includes a central build manager that generates updated compiler flags used by local nodes to compile respective sets of code. An individual local node may delay integration of the updated flags until after compilation of the current job is complete to avoid compilation errors and inconsistent build artifacts. In yet another example, a real-time streaming system includes a central server that maintains updated calibration data for edge nodes that affects downstream processing of sensor data. An individual edge node executes a local process that uses the calibration data to calibrate a streamed output. The edge node may delay incorporation of the updated calibration data until the local process completes a current streaming session to prevent inconsistencies in the streamed output.

### 6. Machine Learning Architecture

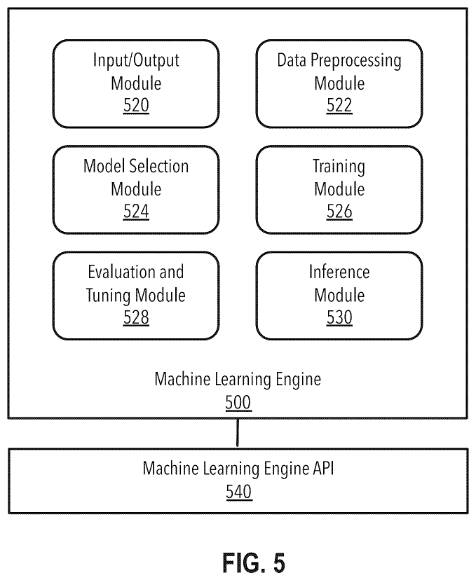

FIG. 5 illustrates an ML engine 500 in accordance with one or more embodiments. The ML engine 500 may be the same or similar to the ML engine previously described above. As illustrated in FIG. 5, ML engine 500 includes input/output module 520, data preprocessing module 522, model selection module 524, training module 526, evaluation and tuning module 528, and inference module 530.

In accordance with an embodiment, input/output module 520 serves as the primary interface for data entering and exiting the system, managing the flow and integrity of data. This module may accommodate a wide range of data sources and formats to facilitate integration and communication within the ML architecture.

In an embodiment, an input handler within input/output module 520 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 520 to be versatile in different operational contexts, whether processing historical datasets or streaming data.

In accordance with an embodiment, input/output module 520 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the ML process.

In an embodiment, an output handler within input/output module 520 includes an output framework designed to handle the distribution and exportation of outputs, predictions, or insights. Using the output framework, input/output module 520 formats these outputs into user-friendly and accessible formats, such as reports, visualizations, or data files compatible with other systems. Input/output module 520 also ensures secure and efficient transmission of these outputs to end-users or other systems in an embodiment and may employ encryption and secure data transfer protocols to maintain data confidentiality.

In accordance with an embodiment, data preprocessing module 522 transforms data into a format suitable for use by other modules in ML engine 500. For example, data preprocessing module 522 may transform raw data into a normalized or standardized format suitable for training ML models and for processing new data inputs for inference. In an embodiment, data preprocessing module 522 acts as a bridge between the raw data sources and the analytical capabilities of ML engine 500.

In an embodiment, data preprocessing module 522 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 522 may be configured to handle anomalies in different ways depending on context. Data preprocessing module 522 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 522 includes a feature encoding framework that ensures categorical variables are transformed into a format that can be easily interpreted by ML algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 522 processes new data for inference, data preprocessing module 522 replicates the same preprocessing steps to ensure consistency with the training data format. This helps to avoid discrepancies between the training data format and the inference data format, thereby reducing the likelihood of inaccurate or invalid model predictions.

In an embodiment, model selection module 524 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 524 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 524 utilizes techniques from the field of Automated ML (AutoML). AutoML systems automate the process of model selection by rapidly prototyping and evaluating multiple models. They use techniques like Bayesian optimization, genetic algorithms, or reinforcement learning to explore the model space efficiently. Model selection module 524 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 524 also considers computational efficiency and resource constraints. This is meant to help ensure the selected model is both accurate and practical in terms of computational and time requirements. In an embodiment, certain features of model selection module 524 are configurable such as a configured bias toward (or against) computational efficiency.

In accordance with an embodiment, training module 526 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 526 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 526 manages overfitting, where a model learns the training data too well, including its noise and outliers, at the expense of its ability to generalize new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 526 includes logic to handle different types of data and learning tasks. For instance, it includes different training routines for supervised learning (where the training data comes with labels) and unsupervised learning (without labeled data). In the case of deep learning models, training module 526 also manages the complexities of training neural networks that include initializing network weights, choosing activation functions, and setting up neural network layers.

In an embodiment, evaluation and tuning module 528 incorporates dynamic feedback mechanisms and facilitates continuous model evolution to help ensure the system's relevance and accuracy as the data landscape changes. Evaluation and tuning module 528 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 528 performs continuous model tuning by using hyperparameter optimization. Evaluation and tuning module 528 performs an exploration of the hyperparameter space using algorithms, such as grid search, random search, or more sophisticated methods like Bayesian optimization. Evaluation and tuning module 528 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 528 integrates data feedback and updates the model. Evaluation and tuning module 528 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 528 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 528 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 530 transforms data raw data into actionable, precise, and contextually relevant predictions. In addition to processing and applying a trained model to new data, inference module 530 may also include post-processing logic that refines the raw outputs of the model into meaningful insights.

In an embodiment, inference module 530 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 530 transforms the outputs of a trained model into definitive classifications. Inference module 530 employs the underlying model as a tool to generate probabilistic outputs for each potential class. It then engages in an interpretative process to convert these probabilities into concrete class labels.

In an embodiment, when inference module 530 receives the probabilistic outputs from the model, it analyzes these probabilities to determine how they are distributed across some or every potential class. If the highest probability is not significantly greater than the others, inference module 530 may determine that there is ambiguity or interpret this as a lack of confidence displayed by the model.

In an embodiment, inference module 530 uses thresholding techniques for applications where making a definitive decision based on the highest probability might not suffice due to the critical nature of the decision. In such cases, inference module 530 assesses if the highest probability surpasses a certain confidence threshold that is predetermined based on the specific requirements of the application. If the probabilities do not meet this threshold, inference module 530 may flag the result as uncertain or defer the decision to a human expert. Inference module 530 dynamically adjusts the decision thresholds based on the sensitivity and specificity requirements of the application, subject to calibration for balancing the trade-offs between false positives and false negatives.

In accordance with an embodiment, inference module 530 contextualizes the probability distribution against the backdrop of the specific application. This involves a comparative analysis, especially in instances where multiple classes have similar probability scores, to deduce the most plausible classification. In an embodiment, inference module 530 may incorporate additional decision-making rules or contextual information to guide this analysis, ensuring that the classification aligns with the practical and contextual nuances of the application.

In regression models, where the outputs are continuous values, inference module 530 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 530 incorporates domain-specific adjustments into its post-processing routine. This involves tailoring the model's output to align with specific industry knowledge or contextual information. For example, in financial forecasting, inference module 530 may adjust predictions based on current market trends, economic indicators, or recent significant events, ensuring that the outputs are both statistically accurate and practically relevant.

In an embodiment, inference module 530 includes logic to handle uncertainty and ambiguity in the model's predictions. In cases where inference module 530 outputs a measure of uncertainty, such as in Bayesian inference models, inference module 530 interprets these uncertainty measures by converting probabilistic distributions or confidence intervals into a format that can be easily understood and acted upon. This provides users with both a prediction and an insight into the confidence level of that prediction. In an embodiment, inference module 530 includes mechanisms for involving human oversight or integrating the instance into a feedback loop for subsequent analysis and model refinement.

In an embodiment, inference module 530 formats the final predictions for end-user consumption. Predictions are converted into visualizations, user-friendly reports, or interactive interfaces. In some systems, like recommendation engines, inference module 530 also integrates feedback mechanisms, where user responses to the predictions are used to continually refine and improve the model, creating a dynamic, self-improving system.

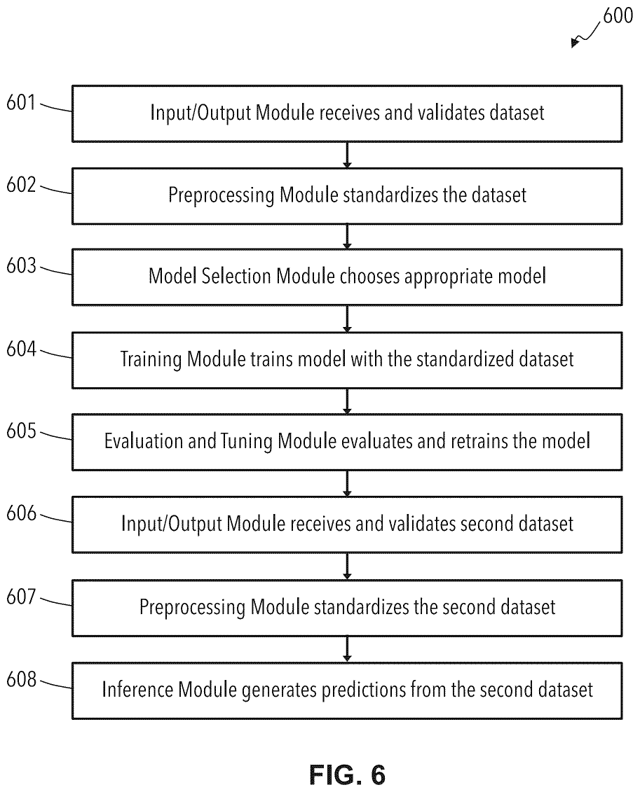

FIG. 6 illustrates an example set of operations 600 for a ML engine 500 in one or more embodiments. In an embodiment, input/output module 520 receives a dataset intended for training (Operation 601). This data can originate from diverse sources, like databases or real-time data streams, and in varied formats, such as CSV, JSON, or XML. Input/output module 520 assesses and validates the data, ensuring its integrity by checking for consistency, data ranges, and types.

In an embodiment, training data is passed to data preprocessing module 522. Here, the data undergoes a series of transformations to standardize and clean it, making it suitable for training ML models (Operation 602). This involves normalizing numerical data, encoding categorical variables, and handling missing values through techniques like imputation.

In an embodiment, prepared data from the data preprocessing module 522 is then fed into model selection module 524 (Operation 603). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 526 trains the selected model with the prepared dataset (Operation 604). It implements learning algorithms to adjust the model's internal parameters, optimizing them to identify patterns and relationships in the training data. Training module 526 also addresses the challenge of overfitting by implementing techniques, like regularization and early stopping, ensuring the model's generalizability.

In an embodiment, evaluation and tuning module 528 evaluates the trained model's performance using the validation dataset (Operation 605). Evaluation and tuning module 528 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 520 receives a dataset intended for inference. Input/output module 520 assesses and validates the data (Operation 606).

In an embodiment, data preprocessing module 522 receives the validated dataset intended for inference (Operation 607). Data preprocessing module 522 ensures that the data format used in training is replicated for the new inference data, maintaining consistency and accuracy for the model's predictions.

In an embodiment, inference module 530 processes the new dataset intended for inference, using the trained and tuned model (Operation 608). It applies the model to this data, generating raw probabilistic outputs for predictions. Inference module 530 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, ML engine API 540 allows applications to leverage ML engine 500. In an embodiment, ML engine API 540 may be built on a RESTful architecture and offer stateless interactions over standard HTTP/HTTPS protocols. ML engine API 540 may feature a variety of endpoints tailored to a specific function within ML engine 500. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, ML engine API 540 is equipped to support SOAP-based interactions. This extension involves defining a WSDL (Web Services Description Language) document that outlines the API's operations and the structure of request and response messages. In an embodiment, ML engine API 540 supports various data formats and communication styles. In an embodiment, ML engine API 540 endpoints may handle requests in JSON format or any other suitable format. For example, ML engine API 540 may process XML, and it may also be engineered to handle more compact and efficient data formats, such as Protocol Buffers or Avro, for use in bandwidth-limited scenarios.

In an embodiment, ML engine API 540 is designed to integrate WebSocket technology for applications necessitating real-time data processing and immediate feedback. This integration enables a continuous, bi-directional communication channel for a dynamic and interactive data exchange between the application and ML engine 500.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

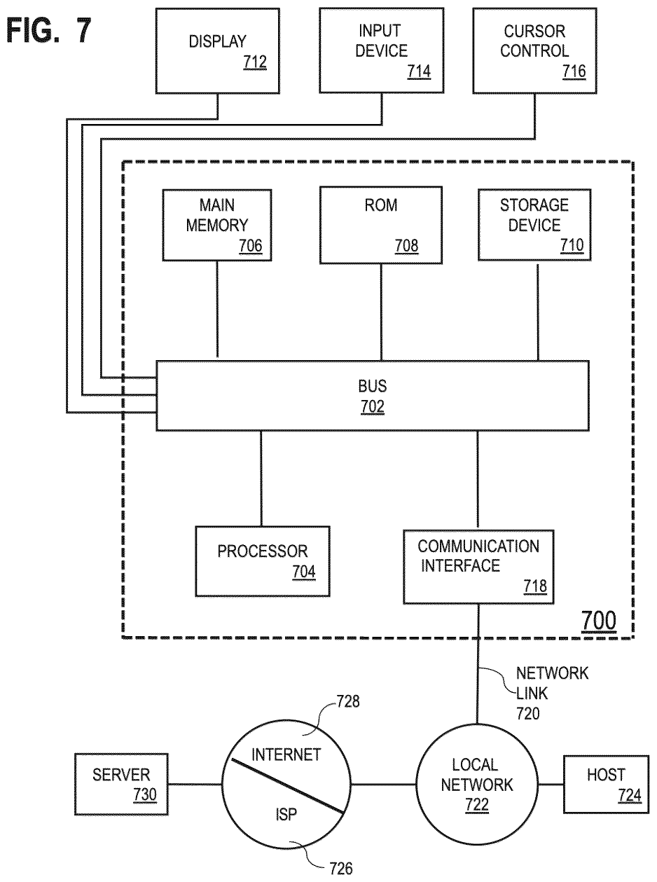

For example, FIG. 7 is a block diagram that illustrates a computer system 700 upon which an embodiment of the disclosure may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory computer-readable storage media accessible to processor 704, render computer system 700 into a special-purpose machine that is customized to perform the operations specified in the instructions.

Computer system 700 further includes a read-only memory (ROM) 708 or other static storage device coupled to bus 702 for storing static information and instructions for processor 704. A storage device 710, such as a magnetic disk, optical disk, or a Solid State Drive (SSD) is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory computer-readable media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infrared data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In such implementations, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
maintaining, at a first memory location, a first dataset, wherein:
the first dataset corresponds to a second dataset maintained at a second memory location, and
the second dataset is to be updated based on updates to the first dataset;
detecting an update to the first dataset results in generation of an updated first dataset;
responsive to detecting that the first dataset has been updated, detecting at a first time a current execution status of a computational process that uses the second dataset, the current execution status indicating that the computational process is incomplete;
responsive to the current execution status indicating that the computational is incomplete, refraining from initiating an update process for updating the second dataset based on the updated first dataset;
detecting at second time, subsequent to the first time, the current execution status of the computational process that uses the second dataset, the current execution status that the computational process has been completed; and
responsive to the current execution status indicating that the computational has been completed, initiating the update process for updating the second dataset based on the updated first dataset,
wherein the update process updates the second dataset to generate an updated second dataset corresponding to the updated first dataset.

2. The non-transitory computer readable media of claim 1, wherein detecting the current execution status of the computational process is incomplete comprises: determining that the computational process has not yet been initiated.

3. The non-transitory computer readable media of claim 1, wherein detecting the current execution status of the computational process is incomplete comprises: determining that the computational process is currently executing.

4. The non-transitory computer readable media of claim 1, wherein detecting the current execution status of the computational process comprises detecting that the one or more data values of the second dataset are required by another computational process is incomplete.

5. One or more non-transitory computer readable media comprising instructions that, when executed by one or more hardware processors, cause performance of operations comprising:
maintaining, at a first memory location, a first dataset, wherein:
the first dataset corresponds to a second dataset maintained at a second memory location, and
the second dataset is to be updated based on updates to the first dataset;
detecting an update to the first dataset that results in generation of an updated first dataset;
responsive to determining that the first dataset has been updated, detecting at a first time a first synchronization state corresponding to the second dataset, the synchronization state indicating (a) that the second dataset is not to be synchronized with the updated first dataset when a computational process that uses the second dataset is incomplete, or (b) the second dataset is to be synchronized with the updated first dataset when the computational process that uses the second dataset has been completed;
responsive to the first synchronization state indicating that the second dataset is not to be synchronized, refraining from initiating an update process for updating the second dataset based on the updated first dataset;
detecting at second time, subsequent to the first time, a second synchronization state corresponding to the second dataset and indicating that the second dataset is to be synchronized with the updated first dataset;
responsive to the second synchronization state indicating that the second dataset is to be synchronized, initiating the update process for updating the second dataset based on the updated first dataset,
wherein the update process updates the second dataset to generate an updated second dataset corresponding to the updated first dataset.

6. The non-transitory computer readable media of claim 5, wherein the operations further comprise:
subsequent to the first time and prior to the second time, detecting that the computational process has been completed;
responsive to detecting that the computational process has been completed, updating (a) the first synchronization state indicating that the second dataset is not to be synchronized with the updated first dataset to (b) the second synchronization state indicating that the second dataset is to be synchronized with the updated first dataset.

7. The non-transitory computer readable media of claim 5, wherein the operations further comprise: detecting the first synchronization state for the second dataset by applying one or more rules corresponding to the second dataset and/or to temporal values.

8. The non-transitory computer readable media of claim 5, wherein the operations further comprise: detecting the first synchronization state for the second dataset by applying a machine learning model trained to classify the second dataset into one of a plurality of synchronization states based on parameters of the second dataset and/or to temporal values.

9. A method comprising:
maintaining, at a first memory location, a first dataset, wherein:
the first dataset corresponds to a second dataset maintained at a second memory location, and
the second dataset is to be updated based on updates to the first dataset;
detecting an update to the first dataset results in generation of an updated first dataset;
responsive to detecting that the first dataset has been updated, detecting at a first time a current execution status of a computational process that uses the second dataset, the current execution status indicating that the computational process is incomplete;
responsive to the current execution status indicating that the computational is incomplete, refraining from initiating an update process for updating the second dataset based on the updated first dataset;
detecting at second time, subsequent to the first time, the current execution status of the computational process that uses the second dataset, the current execution status that the computational process has been completed; and
responsive to the current execution status indicating that the computational has been completed, initiating the update process for updating the second dataset based on the updated first dataset,
wherein the update process updates the second dataset to generate an updated second dataset corresponding to the updated first dataset.

10. The method of claim 9, wherein detecting the current execution status of the computational process is incomplete comprises: determining that the computational process has not yet been initiated.

11. The method of claim 9, wherein detecting the current execution status of the computational process is incomplete comprises: determining that the computational process is currently executing.

12. The method of claim 9, wherein detecting the current execution status of the computational process comprises detecting that the one or more data values of the second dataset are required by another computational process is incomplete.

13. A method comprising:
maintaining, at a first memory location, a first dataset, wherein:
the first dataset corresponds to a second dataset maintained at a second memory location, and
the second dataset is to be updated based on updates to the first dataset;
detecting an update to the first dataset that results in generation of an updated first dataset;
responsive to determining that the first dataset has been updated, detecting at a first time a first synchronization state corresponding to the second dataset, the synchronization state indicating (a) that the second dataset is not to be synchronized with the updated first dataset when a computational process that uses the second dataset is incomplete, or (b) the second dataset is to be synchronized with the updated first dataset when the computational process that uses the second dataset has been completed;
responsive to the first synchronization state indicating that the second dataset is not to be synchronized, refraining from initiating an update process for updating the second dataset based on the updated first dataset;
detecting at second time, subsequent to the first time, a second synchronization state corresponding to the second dataset and indicating that the second dataset is to be synchronized with the updated first dataset;
responsive to the second synchronization state indicating that the second dataset is to be synchronized, initiating the update process for updating the second dataset based on the updated first dataset,
wherein the update process updates the second dataset to generate an updated second dataset corresponding to the updated first dataset.

14. The method of claim 13, further comprising:
subsequent to the first time and prior to the second time, detecting that the computational process has been completed;
responsive to detecting that the computational process has been completed, updating (a) the first synchronization state indicating that the second dataset is not to be synchronized with the updated first dataset to (b) the second synchronization state indicating that the second dataset is to be synchronized with the updated first dataset.

15. The method of claim 13, further comprising: detecting the first synchronization state for the second dataset by applying one or more rules corresponding to the second dataset and/or to temporal values.

16. The method of claim 13, further comprising: detecting the first synchronization state for the second dataset by applying a machine learning model trained to classify the second dataset into one of a plurality of synchronization states based on parameters of the second dataset and/or to temporal values.

17. A system comprising:
at least one device including a hardware processor;
the system being configured to perform operations comprising:
maintaining, at a first memory location, a first dataset, wherein:
the first dataset corresponds to a second dataset maintained at a second memory location, and
the second dataset is to be updated based on updates to the first dataset;
detecting an update to the first dataset results in generation of an updated first dataset;
responsive to detecting that the first dataset has been updated, detecting at a first time a current execution status of a computational process that uses the second dataset, the current execution status indicating that the computational process is incomplete;
responsive to the current execution status indicating that the computational is incomplete, refraining from initiating an update process for updating the second dataset based on the updated first dataset;
detecting at second time, subsequent to the first time, the current execution status of the computational process that uses the second dataset, the current execution status that the computational process has been completed; and
responsive to the current execution status indicating that the computational has been completed, initiating the update process for updating the second dataset based on the updated first dataset,
wherein the update process updates the second dataset to generate an updated second dataset corresponding to the updated first dataset.

18. The system of claim 17, wherein detecting the current execution status of the computational process is incomplete comprises: determining that the computational process has not yet been initiated.

19. The system of claim 17, wherein detecting the current execution status of the computational process is incomplete comprises: determining that the computational process is currently executing.

20. The system of claim 17, wherein detecting the current execution status of the computational process comprises detecting that the one or more data values of the second dataset are required by another computational process is incomplete.
